(19) United States
(12) Patent Application Publication
(10) Pub. No.: US 2017/0282496 A1
(43) Pub. Date: Oct. 5, 2017

(54) MULTI-LAYER COMPOSITE MATERIAL, PRODUCTION METHOD, AND SEMI-FINISHED PRODUCT HAVING METAL SHAPE-MEMORY MATERIAL

(71) Applicant: ThyssenKrupp Steel Europe AG, Duisburg (DE)

(72) Inventors: Andreas Cott, Dortmund (DE); Rainer Fechte-Heinen, Bottrop (DE); Joseph Georg Kevenhörster, Bochum (DE); Lothar Patberg, Moers (DE)

(73) Assignee: ThyssenKrupp Steel Europe AG, Duisburg (DE)

(21) Appl. No.: 15/507,845

(22) PCT Filed: Aug. 21, 2015
(86) PCT No.: PCT/EP2015/069280

§ 371 Date: Mar. 1, 2017

(30) Foreign Application Priority Data
Sep. 4, 2014 (DE) 10 2014 112 772.2

(51) Int. Cl. B32B 7/04; B32B 15/14; B32B 27/28; B32B 5/12; B32B 27/34; B32B 15/20; B32B 15/08

(52) U.S. Cl. CPC B32B 7/04; B32B 15/20; B32B 15/14; B32B 15/08; B32B 5/12; B32B 27/34; B32B 27/285; B32B 2307/50

(57) ABSTRACT

A multilayer composite material may include at least one nonmetallic layer, which in some examples comprises plastic, and at least one metallic layer comprising a first metallic shape memory material. One problem with specifying multilayer composite materials and methods for producing multilayer composite materials relative to reshaping properties can be overcome by providing at least one second metallic layer and disposing the at least two metallic layers on opposite sides of the nonmetallic layer. Further disclosed are methods for producing multilayer composite materials, as well as semi-finished products produced from such multilayer composite materials. Still further disclosed are methods for producing components using such semi-finished products.

The invention relates to a multilayer composite material having at least one nonmetallic layer preferably comprising plastics, and having at least one metallic layer, where the at least one metallic layer comprises a first shape memory material. The invention further relates to a method for producing a multilayer composite material and also to a semi-finished product produced from the multilayer composite material of the invention. The invention relates, furthermore, to a method for producing a component using the semi-finished product of the invention.

Multilayer composite materials are understood to be wholly or partly layered assemblies of at least two different materials in two or more layers. Commonplace are multilayer composite materials, preferably sandwich composite materials composed of three layers, formed for example by an inner core layer joined to two outer facing layers, more particularly facing sheets. These facing sheets comprise a material different from the material of the core layer. The facing sheets may have different materials from one another or the same materials. The layers here are not necessarily surface-covering.

The materials for use in the multilayer composite material, more particularly sandwich composite material, and also the structure and thickness of the layers, may be selected on the basis of their qualities for the particular intended use, in order to obtain, ultimately, a multilayer composite material having an advantageous combination of the qualities of the individual materials. The use of multilayer composite materials is therefore goaled to providing a combination of different physical qualities which could be difficult, expensive or even impossible to realize with a single material.

The desired physical qualities include, for example, high strength, low weight, good corrosion resistance, high economy, and also improved qualities in respect of the joining of materials, by means of welding, soldering, or adhesive bonding, for example. Multilayer composite materials may also feature enhanced shapability and high wear hardness.

Through an advantageous combination of materials it is possible not only, in fact, to generate physical properties in the multilayer composite material that correspond to the sum of the properties of the individual materials. The individual properties may complement one another in such a way that in terms of its properties, the multilayer composite material exceeds the sum of the contributions of the individual materials.

In the goal-directed reshaping of multilayer composite materials, as for example in the reshaping of a sandwich composite material in sheet form into a component by means of die forming, section rolling, or free forming, problems are known, however, from the prior art. For instance, the very fact of the different physical properties of the layers of the multilayer composite material may prove problematic. The layers may respond differently to the shaping operation, such as to the effect of the mechanical exposures in the form of bending, stretching, and shearing. An additional problem arises through the effect of temperature, as a result, for instance, of temperature differences and temperature gradients within the material during the shaping operation, or else as a result of very high temperature settings in the course of hot forming. As a result, not only the individual materials themselves, but also their joining to one another in the multilayer composite material, are burdened.

The manifestations of such problems may be, for example, that the thickness of the material resulting after shaping exhibits unwanted variations. Possible causes for this include differences in displacement of material in the layers in the course of shaping. The layers may also detach from one another, in the form of delamination in the case of laminated composite materials, for example. This structurally weakens the components produced, which additionally have poor dimensional integrity.

Particularly in the case of metallic layers, more particularly facing sheets and layers, more particularly core layers, made from plastics, more particularly from fiber-reinforced plastics, a further challenge arising during shaping, especially of a multilayer composite material, is that high holding forces in the case of steel facing sheets, for example, do diminish creasing, but promote fiber breakage in the core layer. As a result, the degree of shaping of such multilayer composite materials is limited.

As prior art, reference is made to the laid-open specification CN 103 895 287 A1.

On the basis of the prior art, the technical problem addressed by the present invention is that of specifying a multilayer composite material and a method for producing it wherein the aforementioned problems in relation to the shaping properties can be decisively improved or even avoided.

The technical problem identified above is solved, according to a first teaching, in that there is at least one second metallic layer, and the at least two metallic layers are disposed on opposite sides of the nonmetallic layer. By this means it is possible to utilize the properties of the metallic shape memory material in order to maintain the structural integrity of the nonmetallic layer during shaping or under load as well. In particular, the pseudoplastic or pseudoelastic resilience of the metallic shape memory material can be utilized in order to prevent excessive loads on nonmetallic layers or metallic layers without shape memory properties, during shaping. For instance, the transmission of high flexural forces or shearing stresses from metallic layers to nonmetallic layers, for example, can be avoided. The high stretchability of the metallic shape memory material in the pseudoplastic state is advantageous in particular in connection with a nonmetallic layer comprising a stretchable material. Multilayer composite materials in the form of sandwich composite materials which have at least one outer facing layer composed of a shape memory alloy profit in particular, owing to the external metal layers, from the retention of integrity of the nonmetallic layer. For the multilayer composite material of the invention, there is at least one second metallic layer, as for example a second facing sheet comprising a metallic shape memory material, and the at least two metallic layers, as for example the at least two facing sheets, are disposed on opposite sides of the nonmetallic layer, as for example of the core layer. For the disposition of the layers, different combinations are possible—for instance, a plurality of metallic layers may be provided, or else a plurality of nonmetallic layers. In this case it is conceivable for at least one nonmetallic layer to be disposed externally in the multilayer composite material. Preferably, however, at least one nonmetallic layer, more particularly a core layer, is situated internally, and is covered on both sides by metallic layers, as for example by facing sheets. The facing sheets consequently provide a protective function against mechanical loads and aging effects. By this means as well, the multilayer composite material can be joined at the surface, by welding or soldering, for example, to other components, more particularly to metallic components. With further preference, metallic layers disposed on opposite sides of the core layer comprise a metallic shape memory material; more particularly, the metallic layers consist of a metallic shape memory material. As a result, the shaping properties of the individual metallic layers can be combined on both sides, and cooperative activation of the shape memory material of the metallic layers can also be effected. In particular, the construction of the multilayer composite material along the thickness may be symmetrical, and so the multilayer, more particularly the sandwich, composite material has identical shaping properties on both sides. Alternatively, the at least second metallic layer may have no shape memory property.

Metallic shape memory materials, moreover, provide high force-fit forces and form-fit forces. Furthermore, the advantage of metallic shape memory materials over many nonmetallic materials is that they are able to offer surfaces which are of higher grade by virtue of being more resistant to aging and corrosion or in respect of mechanical loads, for example.

The at least one metallic layer, which may function, for example, as a facing sheet, is preferably formed entirely of a metallic shape memory material. As a result, the metallic layer or facing sheet has the advantageous qualities of the metallic shape memory material homogeneously over its surface. It is, however, also possible for the metallic layer or facing sheet to consist only partly of a metallic shape memory material, by incorporation, for example, of stripes, patches or a fabric of metallic shape memory material into the metallic layer or facing sheet.

Furthermore, the shape memory of the at least one metallic layer or at least one facing sheet may be utilized advantageously for the shaping properties of the multilayer composite material. In one preferred refinement of the multilayer composite material, the shape memory material has a shape memory of a shape introduced previously. This allows the shape memory material to be activated by heating it at least to the activation temperature, with the change in shape caused by the shape memory supporting reshaping of the multilayer composite material. Alternatively to the heating-activated shape memory material, it is also possible in accordance with the invention to use a shape memory material which is activated by a magnetic field.

Preferably, as well, the reshaping of the multilayer composite material may take place solely as a result of the activation of the shape memory material. In that case the multilayer composite material is self-reshaping and no further forming tools such as dies or rolls are required for reshaping. The multilayer composite material must only be heated above the activation temperature and/or activated by a corresponding magnetic field, thus considerably reducing the cost and complexity involved in reshaping.

As plastics in the nonmetallic layer, such as in a core layer, for example, it is possible to use thermosetting plastics, which are very temperature-stable. Foamed plastics as well, more particularly those with gas inclusions, are conceivable. In one preferred embodiment, the nonmetallic layer or core layer comprises a thermoplastic. Thermoplastics include, for example, polyolefins, polyamides, polyesters, polyethylenes, polypropylenes, polyurethanes, or a blend of the various plastics. The thermoplastic in the nonmetallic layer or core layer is based preferably on polyamide, polyethylene, or a blend of polyamide and polyethylene, more particularly on a PA6 polyamide with a fraction of grafted polyethylenes and a reactive copolymer. Both thermoplastics can be processed very well and are readily formable in the hot state. In relation to the reshaping properties of the multilayer composite material, therefore, thermoplastics and shape memory materials constitute a highly advantageous material combination. The at least one nonmetallic layer or plastic layer may optionally have shape memory properties.

In accordance with a further refinement of the multilayer composite material, the glass transition temperature or melting temperature of the thermoplastic is situated in the range of ±100° C., more particularly ±50° C., preferably ±25° C. of the activation temperature of the shape memory material. By approximating the glass transition temperature or the melting temperature to the activation temperature it is possible to make optimum use of the advantageous reshaping properties of the shape memory material and of the thermoplastic, since on heating, for example, both materials are brought approximately simultaneously into a highly shapeable state. In that case, in particular, the utilization of the shape memory can occur favorably in connection with the thermoplastic properties. Depending on the desired degree of reshaping, it is possible here, with amorphous thermoplastics, for the glass transition temperature to be decisive, whereas the melting temperature may also be recruited in the case of semicrystalline or highly crystalline thermoplastics. The difference between melting temperature and activation temperature in the case of semicrystalline or highly crystalline thermoplastics may also be selected in accordance with the degree of crystallinity, thus allowing reshaping to be carried out more closely to the melting point in the case of relatively high crystallinity in particular. In this case the glass transition temperature or melting temperature is preferably lower than the activation temperature, and so, when the multilayer composite material is heated, the thermoplastic becomes readily formable first of all, followed by completion of the transition of the shape memory material into the pseudoelastic state and/or activation of the shape memory. The respective temperatures here may be determined under standard conditions, by a Differential Scanning calorimetry method, for example, with a heating rate of 10 K/min, with evaluation in accordance with DIN 51007.

In one advantageous refinement of the multilayer composite material, the nonmetallic layer—core layer, for example—comprises a fiber-reinforced plastic. For that purpose the plastic contains, for example, glass, carbon, aramid, polyethylene, basalt, boron, or metal fibers. Carbon fibers in particular afford maximum strength for lowest weight and are therefore suitable for a multiplicity of applications for which a high load-bearing capacity in conjunction with low weight is a requirement.

The multilayer composite material thus allows the production of components shaped in such a way that draping of fiber fabrics conventionally would cause difficulties, as for example on molding with narrow bends. It has emerged that the force released by activation of the shape memory material is sufficient for reshaping, for draping by the fibers themselves. And the resilience of the pseudo plastic or pseudo elastic shape memory material reduces the risk of fiber breakage on reshaping.

According to a further refinement of the multilayer composite material, the shape memory material used comprises an iron-based shape memory alloy. Shape memory alloys are able to provide very high force-fit or form-fit forces. Examples of shape memory alloys contemplated include nickel-titanium, nickel-titanium-copper-, copper-, nickel-aluminum, copper-aluminum-nickel-, nickel-manganese-gallium-, iron-palladium-, iron-palladium-platinum-, iron-manganese-silicon-, iron-manganese-silicon-chromium, or iron-manganese-silicon-chromium-nickel-based shape memory alloys. The iron systems stated, i.e., iron-manganese-silicon, iron-manganese-silicon-chromium, or iron-manganese-silicon-chromium-nickel, may also be used in mass production, since they are relatively inexpensive by comparison with the other alloy systems. Furthermore, the iron-based systems offer the possibility of ensuring activation of the shape memory properties by efficient inductive heating, allowing the activation to be accomplished in a particularly simple way and introduced in a targeted way—including partially. Similar comments apply in respect of other iron-based alloys.

Besides iron and unavoidable impurities, for example, the shape memory alloy comprises the following alloy elements in wt %:
12%≦Mn≦45%,
1%≦Si≦10%,
Cr≦20%,
Ni≦20%,
Mo≦20%,
Cu≦20%,
Co≦20%,
Al≦10%,
Mg≦10%,
V≦2%,
Ti≦2%,
Nb≦2%,
W≦2%,
C≦1%,
N≦1%,
P≦0.3%,
Zr≦0.3%,
B≦0.01%.

An alloy system of this kind can be tailored very well to the specific strength properties through the selection of the various alloying components. The strength is increased, for example, significantly on the addition of carbon, chromium, molybdenum, titanium, niobium, or vanadium.

Addition of manganese, carbon, chromium, or nickel stabilize the austenite phase, which can be utilized for an increase in the activation temperature. A combination of at least one element from the groups of vanadium, titanium, niobium, and tungsten on the one hand and at least one element from the groups of carbon, nitrogen, and boron on the other hand leads to the formation of precipitates in the microstructure and hence to the simplification or elimination of thermomechanical material treatment, since, for example, the tension field around the precipitates is utilized as a nucleation site of the phase transformation.

A pseudo plastic or pseudo elastic shape memory alloy may be provided, for example, if the shape memory alloy, in addition to iron and unavoidable impurities, comprises the following alloying elements in wt %:
25%≦Mn≦32%,
3%≦Si≦8%,
3%≦Cr≦6%,
Ni≦3%,
C≦0.07%, preferably 0.01%≦C≦0.07%, and/or
N≦0.07%, preferably 0.01%≦N≦0.07%,
0.1%≦Ti≦1.5% or
0.1%≦Nb≦1.5% or
0.1%≦W≦1.5% or
0.1%≦V≦1.5%.

According to a further embodiment of the multilayer composite material, of a sandwich composite material, for example, the thickness of the metallic layer, of the facing sheet, for example, is between 0.15 and 1.0 mm, more particularly between 0.2 and 0.5 mm. It has emerged that the stated thickness range allows easy reshaping of the multilayer composite material and at the same time also provides a high degree of stability, while allowing sufficient heat transit into the core layer. Moreover, on activation of the shape memory material, a metallic layer in the stated thickness range exerts sufficient reshaping forces for the shaping of the multilayer composite material, especially in connection with a nonmetallic layer which comprises a fiber-reinforced plastic. In the case of sandwich composite materials, the nonmetallic layer may also be designed as a core layer.

The thickness of the nonmetallic layer is preferably between 0.3 and 2.0 mm, more particularly between 0.4 and 1.0 mm. At the layer thicknesses stated, the composite first of all has the necessary strength and stiffness. Furthermore, sufficient weight reduction is achieved in comparison to a solid material. With further preference, the ratio of the thickness of the metallic layer to the thickness of the nonmetallic layer is between 0.4 and 0.6, more particularly between 0.45 and 0.55. This ratio has emerged as advantageous for the reshaping properties with activation of the shape memory material.

In a further embodiment of the multilayer composite material, one of the metallic layers, more particularly one of the facing sheets, comprises aluminum or an aluminum alloy. Preferably one of the metallic layers consists entirely of aluminum or an aluminum alloy. Aluminum or aluminum alloys are suitable on account of their low weight particularly for lightweight multilayer composite materials. A combination of carbon fiber-reinforced plastics in a core layer, for example, with at least one facing sheet comprising aluminum or aluminum alloy, in particular, produces a combination of low weight of the multilayer composite material with high strength. On account of their high corrosion resistance, aluminum or aluminum alloys are also advantageous for use in an outer facing sheet. Where aluminum or aluminum alloys are not used as shape memory material, they can be reshaped particularly easily, on account of their low yield point, if they are combined in a multilayer composite material with at least one metallic layer composed of shape memory material.

The multilayer composite material may, however, additionally have further metallic layers, more particularly facing sheets, more particularly outer facing sheets, for corrosion control, for example. Also conceivable is a single-sided or double-sided coating of the metallic layers or nonmetallic layers, using metallic, organic, or inorganic-organic coatings, for example. Such coatings may in particular have the function of a corrosion control layer or may bring about a desired optical effect.

The multilayer composite material is preferably in coil or sheet form. This allows further processing to take place economically with high operational reliability; it facilitates handling and transport and also the storage of the multilayer composite material.

In accordance with a second teaching of the present invention, the aforementioned technical problem is solved in relation to a method for producing a multilayer composite material, more particularly a multilayer composite material of the invention, wherein at least one metallic layer comprising a shape memory material is joined to at least one nonmetallic layer preferably comprising plastic.

The joining between the at least one metallic layer and at least one nonmetallic layer, as for example the facing sheet and the core layer, is made possible in particular through the influence of pressure and temperature. The joining may be produced, for example, by rolling, calendering, laminating, adhesively bonding, or extruding the nonmetallic layer onto the metallic layer. The material of the nonmetallic layer may already have been brought into a layer form prior to joining, and may only then be joined to the metallic layer. An alternative possibility is to join the material of the nonmetallic layer, by means of calendering or extrusion, for example, to the metallic layer directly during production of the nonmetallic layer.

In the method, in one preferred embodiment, for example, a first metallic, metallic layer comprising a shape memory material is heated at least to the activation temperature and preshaped, and subsequently the metallic layer comprising a shape memory material is cooled to a temperature below the activation temperature and reshaped. Consequently the self-reshaping quality of the shape memory can be utilized in the multilayer composite material produced. The metallic layer in this case may be preshaped and reshaped, for example, before being joined to the nonmetallic layer. Also possible is to produce the joining of metallic layer and nonmetallic layer first, and then to carry out preshaping and reshaping of the metallic layer in the multilayer composite material.

The reshaping of the metallic layer comprising the shape memory material may be carried out concurrently with the joining of the nonmetallic layer preferably comprising plastics. After the preshaping of the metallic layer has taken place, therefore, the multilayer composite material can be produced in a single further combined work step, which increases the economy of the method. The material of the nonmetallic layer in this case is based preferably on a thermoplastic, in view of the requirements concerning the reshapability of the nonmetallic layer and the possibility of bringing property-determining temperatures of the nonmetallic layer into a targeted relationship with the activation temperature of the shape memory material. Where a fiber-reinforced plastic is used, it is possible in particular for the reshaping of the metallic layer to take place concurrently with the laminating of the fibers in a plastics matrix.

In another embodiment, the nonmetallic layer is joined to at least one second metallic layer which consists preferably of a shape memory material. By the provision of at least one second metallic layer with shape memory, the multilayer composite material can be given additional reshapability and stability. In particular, a symmetrical disposition of the layers is made possible by this means.

The nonmetallic layer may be joined to at least one further metallic layer which comprises aluminum or an aluminum alloy. Aluminum or aluminum alloy, in addition to low weight and high corrosion resistance, also exhibit good properties in connection with rolling or pressing, and so metallic layers comprising aluminum or an aluminum alloy can be processed in an economically advantageous and operationally reliable manner.

In the method of the invention it is also possible for additional metallic or nonmetallic layers to be processed, especially in conjunction with additional coatings.

In one advantageous embodiment, the multilayer composite material can be produced in a coil-to-coil process. This allows an economic and operationally reliable method. In this case the metallic layer or metallic layers may be provided on a coil and unwound. The material of the nonmetallic layer may likewise be available on a coil, more particularly in prefabricated form. In the case of a nonmetallic layer based on a fiber-reinforced plastic, the components of the plastic, the fiber fabric and the plastics matrix, may likewise be provided on coils and unwound. The winding of the multilayer composite material produced into a coil allows economic further processing, facilitates handling and transport, and also facilitates the storage of the multilayer composite material produced.

Furthermore, the multilayer composite material can be produced in a coil-to-sheet process. As a result, the multilayer composite material can first be produced, economically and in an operationally reliable manner, in a coil form, and can subsequently be cut to form sheets. Sheets simplify the handling of the multilayer composite material and in particular are readily stackable. As early as during the production method, additionally, the sheets can be brought to a size which corresponds to the size required for further processing.

In accordance with third and fourth teachings, the technical problem stated above is solved by a semi-finished product produced from a multilayer composite material of the invention, and also by a method for producing a component using a semi-finished product of the invention, wherein the semi-finished product is heated at least to the activation temperature of the shape memory material and/or is activated by a magnetic field, and the semi-finished product reshapes itself via the shape memory of the shape memory material to form the desired component.

A semi-finished product of the invention is provided, for example, from the multilayer composite material of the invention, with the shape memory material having a shape memory via a shape which is different from the shape of the shape memory material in the multilayer composite material. This semi-finished product may be in coil form or in the form of sheets, but may optionally have already been cut with a view to the ultimate shape of the component to be produced, in the technical or geometric sense. As a result, the semi-finished product is advantageous in its properties, as for example in handling, during transport, or during use thereof in the production operation. The semi-finished product may be supplied to the customer in the corresponding simple form, as a sheet or coil, for example.

The production of the component from the semi-finished product is greatly simplified by the reshaping properties of the shape memory material. The shape stored in the shape memory preferably already corresponds to the ultimate shape of the component. Accordingly, by heating of the semi-finished product and/or by corresponding magnetic fields, the shape memory material can be activated and the component can be produced. No further shaping tools are needed for this purpose.

Regarding the refinements and advantages of the method for producing a multilayer composite material, of the semi-finished product produced from a multilayer composite material of the invention, and of the method for producing a component using a semi-finished product of the invention, reference is further made to the details given concerning the multilayer composite material of the invention, and also to the drawing. In the drawing

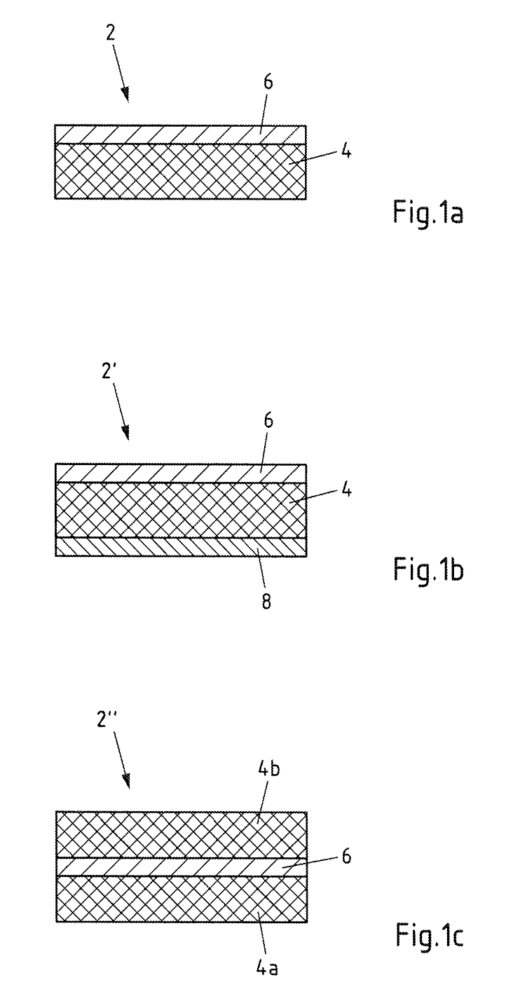

FIG. 1a) shows in a sectional view, a first exemplary embodiment of a multilayer composite material,

FIG. 1b) shows, in a sectional view, a second exemplary embodiment of a multilayer composite material,

FIG. 1c) shows in a sectional view a third exemplary embodiment of a multilayer composite material,

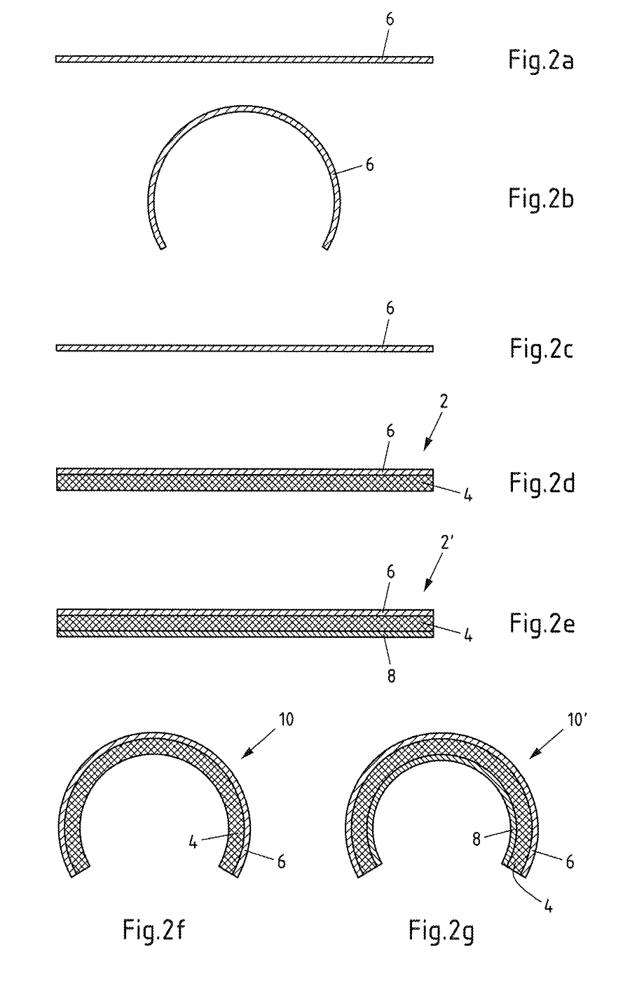

FIG. 2a)-e) show, in a sectional view, an exemplary embodiment of a method for producing a multilayer composite material,

FIG. 2f)-g) show, in a sectional view, two components produced from the multilayer composite material of the invention,

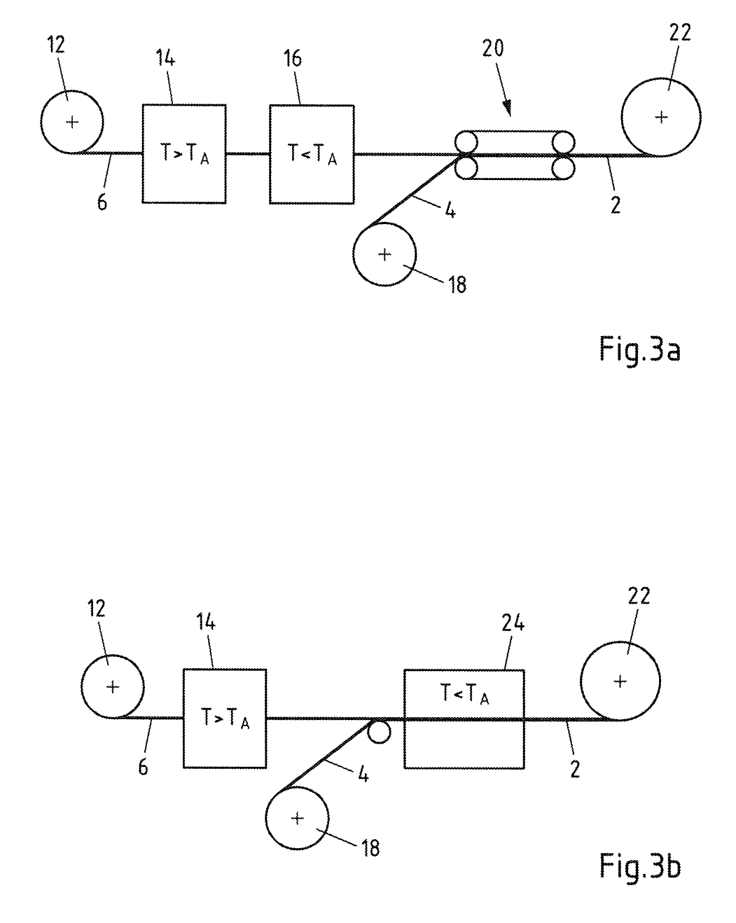

FIG. 3a) shows a first exemplary embodiment of a schematic construction of a method for producing a multilayer composite material in a coil-to-coil process,

FIG. 3b) shows a second exemplary embodiment of a schematic construction of a method for producing a multilayer composite material in a coil-to-coil process,

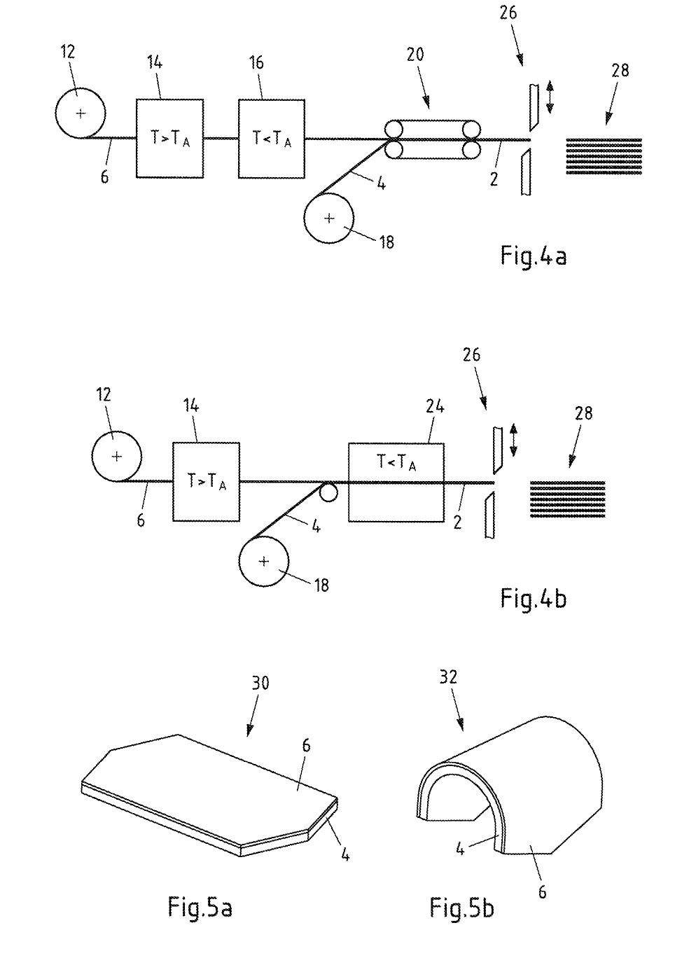

FIG. 4a) shows a third exemplary embodiment of a schematic construction of a method for producing a multilayer composite material in a coil-to-sheet process,

FIG. 4b) shows a fourth exemplary embodiment of a schematic construction of a method for producing a multilayer composite material in a coil-to-sheet process,

FIG. 5a) shows an exemplary embodiment of a semi-finished product composed of a multilayer composite material of the invention, in a perspective representation,

FIG. 5b) shows a component produced from the semi-finished product from FIG. 5a), in a perspective representation.

FIG. 1a) shows, in a sectional view, a first exemplary embodiment of a multilayer composite material 2, wherein a nonmetallic core layer 4, preferably comprising plastics, is joined to a metallic layer, preferably a facing sheet 6, which comprises a metallic shape memory material. The facing sheet 6 preferably comprises an iron-based shape memory alloy, and the core layer 4 preferably comprises a fiber-reinforced thermoplastic, as for example a carbon fiber-reinforced blend of polyamide and polyethylene. In particular, the shape memory material of the facing sheet 6 has a shape memory of a shape which is different from the shape shown here of the shape memory material in the multilayer composite material.

FIG. 1b) shows, in a sectional view, a second exemplary embodiment of a multilayer composite material 2′, wherein, in comparison to the exemplary embodiment shown in FIG. 1a), a further metallic facing sheet 8 is joined to the core layer 4 on the side opposite the facing sheet 6. The further facing sheet 8 here may comprise different materials, as for example aluminum or an aluminum alloy. The facing sheet 8, however, may also comprise a metallic shape memory material, like the facing sheet 6. In this case, in particular, the shape memory material of the facing sheet 8 may have a shape memory which corresponds to the shape memory of the first facing sheet 6, and so the reshaping properties of the facing sheets 6, 8 support one another on activation. In particular the facing sheets 6, 8 also approximately have the same thickness, and so the multilayer composite material is approximately symmetrical along its thickness. Alternatively it is also possible to use a metallic facing sheet 8 without shape memory quality.

Alternatively, as shown in FIG. 1c), the multilayer composite material 2″ may have two or more nonmetallic layers as core layers 4a, 4b, in which case a metallic layer 6 with shape memory is disposed between the layers 4a, 4b. A multiplicity of further combinations and dispositions of the layers are conceivable.

FIG. 2a)-e) show, in a sectional view, an exemplary embodiment of a method for producing a multilayer composite material 2, 2′. First of all, in FIG. 2a) a metallic layer is provided, a metallic facing sheet 6 which comprises a shape memory material, for example. This facing sheet 6 may be in coil form. The facing sheet is heated at least to the activation temperature of the shape memory material and is preshaped, into a circular or oval shape, for example, as shown in FIG. 2b). Optionally thereafter the facing sheet in FIG. 2c) is cooled to a temperature below the activation temperature and reshaped, back into a coil form, for example. The activation may alternatively be brought about, for example, via a corresponding magnetic field. Lastly, the facing sheet 6 is joined to a nonmetallic layer, such as to the core layer 4, for example, in which case the reshaping of the facing sheet 6 may take place before the joining to the core layer 4, as shown in FIG. 2c), or simultaneously with the joining to the core layer 4 in FIG. 2d). The multilayer composite material 2 in FIG. 2d) then corresponds to the exemplary embodiment shown in FIG. 1a), with the shape memory material having a shape memory via the shape shown in FIG. 2b) or, alternatively, a shape between FIG. 2b) and FIG. 2a), if the shape memory effect is designed such that no complete return to shape takes place.

As shown in FIG. 2e), a metallic layer, as for example a further facing sheet 8, may be joined to the core layer 4, in which case the facing sheet 8, subsequently to or else simultaneously with the joining of the first facing sheet 6 to the core layer 4, may be disposed in the multilayer composite material 2′. The multilayer composite material 2′ in FIG. 2e) then also corresponds to the exemplary embodiment shown in FIG. 1b), with the shape memory material having a shape memory via the shape shown in FIG. 2b) or having a shape between FIG. 2b) and FIG. 2a).

FIG. 2f) shows, in a sectional view, a component 10 produced from the multilayer composite material 2 shown in FIG. 2d). The component 10 may be produced by means of forming tools, in which case, additionally, the reshaping qualities of the shape memory material may be utilized by heating at least to the activation temperature. In particular, however, the production of the component 10 is accomplished only by the heating of the multilayer composite material 2 at least to the activation temperature at which the shape memory of the shape memory material in the facing sheet 6 is activated, and the shape of the facing sheet 6 from FIG. 2b), or a shape between FIG. 2b) and FIG. 2a), is re-established. In that case the multilayer composite material 2 is a self-reshaping material.

In analogy to this, FIG. 2g) shows a component 10′ produced from the multilayer composite material 2′ shown in FIG. 2e).

FIG. 3a) shows a first exemplary embodiment of a schematic construction of a method for producing a multilayer composite material 2 in a coil-to-coil process, wherein first of all a metallic facing sheet 6 in coil form is unwound from a coil 12. In a first preshaping stage 14, the facing sheet 6 is heated at least to the activation temperature T_{A} and preshaped. Subsequently, in the second, reshaping stage 16, the facing sheet 6 is cooled below the activation temperature T_{A} and reshaped, to regain the coil form, for example. The material of the core layer 4 is unwound from a second coil 18 and joined to the facing sheet 6 to form a multilayer composite material 2, in a joining apparatus 20—for example, as shown here, by means of a coil press. Shown in simplified form in FIGS. 3 and 4 is only one coil 18 for the provision of the material of the core layer 4; however, for fiber-reinforced plastics within the core layer, in particular, it is possible to use a plurality of coils—for example, separate coils for a fiber fabric and a plastics matrix. Lastly, the multilayer composite material 2 produced is wound onto a further coil 22.

FIG. 3b) shows a second exemplary embodiment of a schematic construction of a method for producing a multilayer composite material 2 in a coil-to-coil process. The method shown in FIG. 3b) differs from the method shown in FIG. 3a) in that in FIG. 3b), instead of a separate second reshaping stage 16 and a joining apparatus 20, the reshaping of the facing sheet 6 below the activation temperature T_{A}, and the joining to the core layer 4, is brought about in a single joining apparatus 24. In this way it is possible to economize by one method step.

FIG. 4a) shows a third exemplary embodiment of a schematic construction of a method for producing a multilayer composite material 2 in a coil-to-sheet process. The method shown in FIG. 4a) differs from the method shown in FIG. 3a) in that in FIG. 4a) the multilayer composite material 2 is not wound onto a coil 22, but is instead processed to sheets 28 in a coil divider 26 downstream of the joining apparatus 20.

FIG. 4b) shows a fourth exemplary embodiment of a schematic construction of a method for producing a multilayer composite material in a coil-to-sheet process, in which, in analogy to FIG. 3b), the reshaping of the facing sheet 6 below the activation temperature T_{A} and the joining to the core layer 4 is brought about in a single joining apparatus 24.

FIG. 5a) shows an exemplary embodiment of a semi-finished product 30 composed of a multilayer composite material of the invention, in a perspective representation. In this exemplary embodiment, the semi-finished product is produced from a multilayer composite material 2 with a core layer 4 and a facing sheet 6. The multilayer composite material 2 here has already been cut into a shape corresponding to the component 10 to be produced, and has goal-directed technical properties which take account of the shape memory effect.

For producing the component 32 in FIG. 5b), the semi-finished product 30 may first be heated at least to the activation temperature of the shape memory material and subsequently, in particular with incorporation of a shape memory, may be reshaped into the ultimate shape of the component 32. The facing sheet 6 of the semi-finished product 30 preferably has a shape memory via a shape which corresponds to the component 32 to be produced. In that case the component 32 can be produced only by heating of the semi-finished product 30 above the activation temperature T_{A}, through activation of the shape memory material, without further forming tools.

1.-20. (canceled)

21. A multilayer composite material comprising:
a nonmetallic layer;
a first metallic layer comprising a metallic shape memory material; and
a second metallic layer, wherein the first and second metallic layers are disposed on opposite sides of the nonmetallic layer.

22. The multilayer composite material of claim 21 wherein the metallic shape memory material has a shape memory of a shape introduced previously to the metallic shape memory material.

23. The multilayer composite material of claim 21 wherein the nonmetallic layer comprises a thermoplastic.

24. The multilayer composite material of claim 23 wherein a glass transition temperature or a melting temperature of the thermoplastic is in a range of ±100° C. of an activation temperature of the metallic shape memory material.

25. The multilayer composite material of claim 21 wherein the nonmetallic layer comprises fiber-reinforced plastic.

26. The multilayer composite material of claim 21 wherein the metallic shape memory material comprises an iron-based shape memory alloy.

27. The multilayer composite material of claim 21 wherein a thickness of the first metallic layer is between 0.15 and 1.0 mm.

28. The multilayer composite material of claim 21 wherein a thickness of the nonmetallic layer is between 0.3 and 2.0 mm.

29. The multilayer composite material of claim 21 wherein the second metallic layer comprises a metallic shape memory material.

30. The multilayer composite material of claim 21 wherein one of the first and second metallic layers comprises aluminum or an aluminum alloy.

31. The multilayer composite material of claim 21 configured in a coil form.

32. A method for producing a multilayer composite material that comprises a nonmetallic layer comprising plastic, a first metallic layer comprising a metallic shape memory material, and a second metallic layer, with the first and second metallic layers being disposed on opposite sides of the nonmetallic layer, the method comprising:
joining the first metallic layer to the nonmetallic layer; and
joining the nonmetallic layer to the second metallic layer.

33. The method of claim 32 further comprising:
heating the first metallic layer at least to an activation temperature;
preshaping the first metallic layer; and
cooling the first metallic layer to a temperature below the activation temperature after the first metallic layer is heated and preshaped; and
reshaping the first metallic layer.

34. The method of claim 33 wherein the reshaping of the first metallic layer is performed concurrently with the joining of the first metallic layer to the nonmetallic layer.

35. The method of claim 32 wherein the second metallic layer comprises a shape memory material.

36. The method of claim 32 further comprising joining the nonmetallic layer to third metallic layer, the third metallic layer comprising aluminum or an aluminum alloy.

37. The method of claim 32 wherein the multilayer composite material is produced in a coil-to-coil process.

38. The method of claim 32 wherein the multilayer composite material is produced in a coil-to-sheet process.

39. A semi-finished product produced from a multilayer composite material that comprises a nonmetallic layer, a first metallic layer comprising a metallic shape memory material, and a second metallic layer, with the first and second metallic layers being disposed on opposite sides of the nonmetallic layer.

40. A method for producing a component using the semi-finished product of claim 39, wherein the semi-finished product is heated at least to an activation temperature of the metallic shape memory material, wherein the semi-finished product reshapes itself via a shape memory of the metallic shape memory material.
